(19) United States
(12) Patent Application Publication
(10) Pub. No.: US 2005/0040575 A1
(43) Pub. Date: Feb. 24, 2005

(54) Universal brake assembly

(76) Inventors: Michael E. Ring, Saint John, IN (US); Gary L. Voong, Bolingbrook, IL (US); Eric S. Graves, Crown Point, IN (US); Frank E. Tinch, Bourbonnais, IL (US)

Correspondence Address: JAMES RAY & ASSOCIATES, 2640 Pitcairn Road, Monroeville, PA, 15146, US

(21) Appl. No.: 10/645,035

(22) Filed: Aug. 21, 2003

(51) Int. Cl. F16M 5/00

(52) U.S. Cl. 267/140.12

(57) ABSTRACT

An air spring actuated brake assembly for a railway vehicle braking system is provided which comprises an air spring disposed between a mounting member for attachment to the rigid structure of the braking system and a push rod attached thereto for longitudinal movement in an outward direction upon actuation thereof to initiate a braking sequence of the railway vehicle braking system. The air spring actuated brake assembly of the present invention allows for improved control of the brake shoe forces including visual travel measurement indication which is especially desirable during light load conditions. Additionally the air spring actuated brake assembly of the invention allows for the visual inspection and simple replacement of an inflatable spring should an air leak in the actuator occur. Currently used brake assemblies employing cylinder type actuators may be retrofitted with the air spring actuator of the invention.

### FIELD OF THE INVENTION

The present invention relates, in general, to a brake mechanism for use in railway vehicle brake assemblies and, more particularly, this invention relates to a brake mechanism using an air spring actuator for initiating a braking sequence in railway vehicle brake assemblies and, still more specifically, the invention relates to truck-mounted brake assemblies.

### BACKGROUND OF THE INVENTION

As is generally well known in the railway industry, truck mounted braking systems comprise a series of force transmitting members, levers and linkages which function to move a group of brake shoes against the wheels of a railway vehicle to effect stoppage of such railway vehicle. A pneumatically activated brake cylinder is typically provided in the braking system to initiate movement of this series of force transmitting members, levers and linkages to apply the brakes of the railway vehicle mounted to a truck assembly of said railway vehicle.

A well known type of truck mounted braking system is a TMX.RTM. truck mounted braking system (TMX.RTM. is a registered trademark to Westinghouse Airbrake Company, the assignee of the present invention) . A currently used pneumatically activated brake cylinder for truck mounted braking systems generally comprises of an air cylinder piston which moves in a forwardly direction within a cylindrical member upon the application of pneumatic pressure thereto. A seal and/or diaphragm is provided on or adjacent a first end of the piston. This seal and/or diaphragm contacts the inner surface of the cylindrical member so as to provide an airtight chamber at one end of the cylindrical member such that application of pneumatic pressure therein and against the first end of the piston enables forward movement of the piston. A piston rod is attached at a second end of the piston and moves in response to the movement of the piston. An opposite end of the piston rod is connected to the end of a push rod which is, in turn, connected to a cylinder force transfer lever. This cylinder force transfer lever is connected through a series of force transmitting members and linkages so as to activate a braking sequence and apply the brake shoes to the vehicle wheels.

A disadvantage of this type of pneumatically activated brake cylinder is that due to regulations regarding the amount of air pressure which must be supplied into the brake cylinder, it is sometimes difficult to control the movement and/or force applied by the piston. Some countries require that a certain amount of pressure, such as at least 1-1.15 bar greater than atmosphere, be applied within the brake cylinder. During light load conditions, too much force applied by the piston can cause the brake shoe forces to be greater than necessary resulting in wheel skid.

Another disadvantage is that care must be taken in the maintenance of the seals and/or diaphragms within the cylindrical member to ensure that leaking of air does not occur, resulting in a loss of pressure and a reduced amount of force being applied by the piston/piston rod assembly. Also, when cracking and/or deterioration of the seals and/or diaphragms does occur, the air brake cylinder must be completely disassembled in order to repair or replace the defective components. The difficulty in determining the condition of the components lies in that the components are contained within the cylindrical member thus resulting in a need for disassembly for inspection purposes.

An additional disadvantage of the currently used air brake cylinders is their inability to accommodate piston bail or misalignment without leaking air. In addition, it is impractical to visually determine the proper relationship between the actual stroke of the cylinder and the brake shoe force during braking.

U.S. Pat. No. 6,116,385, Dual Force Range TMX Cylinder Using an Airspring Actuator teaches a pneumatically activated brake cylinder which comprises a cylindrical casing engaged with a railway vehicle braking system. A hollow piston assembly having a first surface and an opposed second surface is mounted for reciprocal movement within the cylindrical casing. There is at least one air spring actuator engageable with the first surface of the hollow piston assembly and an opposed inner surface of such cylindrical casing. An air communication means is in fluid communication with an interior portion of the at least one air spring actuator for allowing the application and removal of air from the air spring actuator during a brake application or a brake release, and a piston rod assembly is associated with the opposed second end of the hollow piston assembly. This piston rod assembly is capable of movement in an outward direction from the cylindrical casing upon actuation of the air spring actuator to initiate a braking sequence for the railway vehicle braking system. The air communication means comprises an air inlet means which is provided in the cylindrical casing and the air spring actuator to enable application of pneumatic pressure within the air spring to form a first air cavity.

A packing cup is provided on the hollow piston assembly producing a seal between the hollow piston assembly and the inner surface of the cylindrical member to form a second air cavity. An air inlet flange is also provided on the cylindrical member to enable the application into and the evacuation of air from the second cavity.

The teaching of U.S. Pat. No. 6,116,385, Dual Force Range TMX Cylinder Using an Airspring Actuator is incorporated herein by reference thereto.

Although the TMX.RTM braking system offers improved performance of the airbrake cylinder in certain applications, there is a need for a simpler device having less components.

### SUMMARY OF THE INVENTION

The universal brake assembly of the present invention comprises a mounting member for attachment to the rigid structure of the braking system having a substantially planar first surface. A push rod/shield actuation member is engaged with the force transmitting linkage of the brake assembly and has a first substantially planar surface. At least one air spring actuator is engageable with the first planar surface of the mounting bracket and with the first planar surface of such push rod/shield actuator for reciprocal motion therein. There is an air communication means in fluid communication with the at least one air spring actuator for allowing the application and removal of air from the air spring actuator during a brake application or a brake release. The push rod/shield actuating member is capable of longitudinal movement in an outward direction upon actuation thereof to initiate a braking sequence of the railway vehicle braking system. The air communication means comprises an air inlet means which is provided in the air spring actuator to enable application of pneumatic pressure regulated by an external control circuit. A visual travel indicator means is provided to permit determination of the forces generated upon pressurization of the air spring actuator that vary with respect to the travel height of such air spring actuator due to the natural characteristics of the rubber. Guiding means includes engagement of a first edge surface and a second edge surface of the push rod/shield actuator with the first edge surface and second edge surface of the mounting bracket, respectively, to substantially minimize loading forces onto such brake actuator due to linkage bail and/or misalignment.

### OBJECTS OF THE INVENTION

It is an object of the present invention to provide an air spring actuated brake mechanism assembly for a railway vehicle braking system which allows for improved control of the brake shoe forces.

Another object of the present invention is to provide an air spring actuated brake mechanism which allows for a reduced amount of pressure to be applied to the air spring actuator pushrod during light car conditions.

Still another object of the present invention is to provide an air spring actuated brake mechanism assembly which is capable of linkage bail and/or misalignment without leaking air.

Yet another object of the present invention is to provide an air spring actuated brake mechanism assembly which requires less maintenance to maintain the air tightness of the system and allows for the simple replacement of an inflatable spring should an air leak in the actuator occur.

A further object of the present invention is to provide an air spring actuated brake mechanism assembly which provides an economically desirable alternative to the seal/diaphragm system currently in use.

Still yet another object of the present invention is to provide an air spring actuated brake mechanism assembly which includes a means for visual inspection of the air spring actuator that does not require disassembly of the mechanism.

Yet still another object of the present invention is to provide an air spring actuated brake mechanism assembly which includes means for visual determination of the air spring actuator travel during a brake actuation in order to determine the force applied by the air brake shoe.

An additional object of the present invention is to provide an air spring actuated brake mechanism assembly which has a positive stop in order to prevent over compression and consequently damage to the air spring actuator.

Yet an additional object of the present invention is to provide an air spring actuated brake mechanism assembly which can be easily retrofitted into existing applications.

Although a number of objects and advantages of the present invention have been described in some detail above, various additional objects and advantages of the brake cylinder of the present invention will become more readily apparent to those persons who are skilled in the art from the following more detailed description of the invention, particularly when such detailed description of the invention is taken in conjunction with both the attached drawing figures and with the appended claims.

### BRIEF DESCRIPTION OF THE DRAWINGS

FIG. 1 is a perspective view of a railway vehicle truck mounted brake arrangement including a presently preferred embodiment of the universal brake assembly of the present invention.

FIG. 2 is a partial perspective view of a railway vehicle truck mounted brake arrangement showing the air spring actuator of the present invention.

FIG. 3 is a perspective view of the air spring actuator assembly.

FIG. 4 is a partial perspective view of the push rod/shield actuator showing application of the wear resistant members.

FIG. 5 is a partial perspective view of the push rod/shield actuator showing application of the wear resistant edge alternatives.

### DETAILED DESCRIPTION OF A PRESENTLY PREFERRED AND VARIOUS ALTERNATIVE EMBODIMENTS OF THE INVENTION

Prior to proceeding with the more detailed description of the invention, a description of a truck mounted braking system and its functioning should provide helpful in understanding the present invention. Also, it should be noted that for the sake of clarity, identical components which have identical functions have been identified with identical reference numerals throughout the several views illustrated in the attached drawing figures.

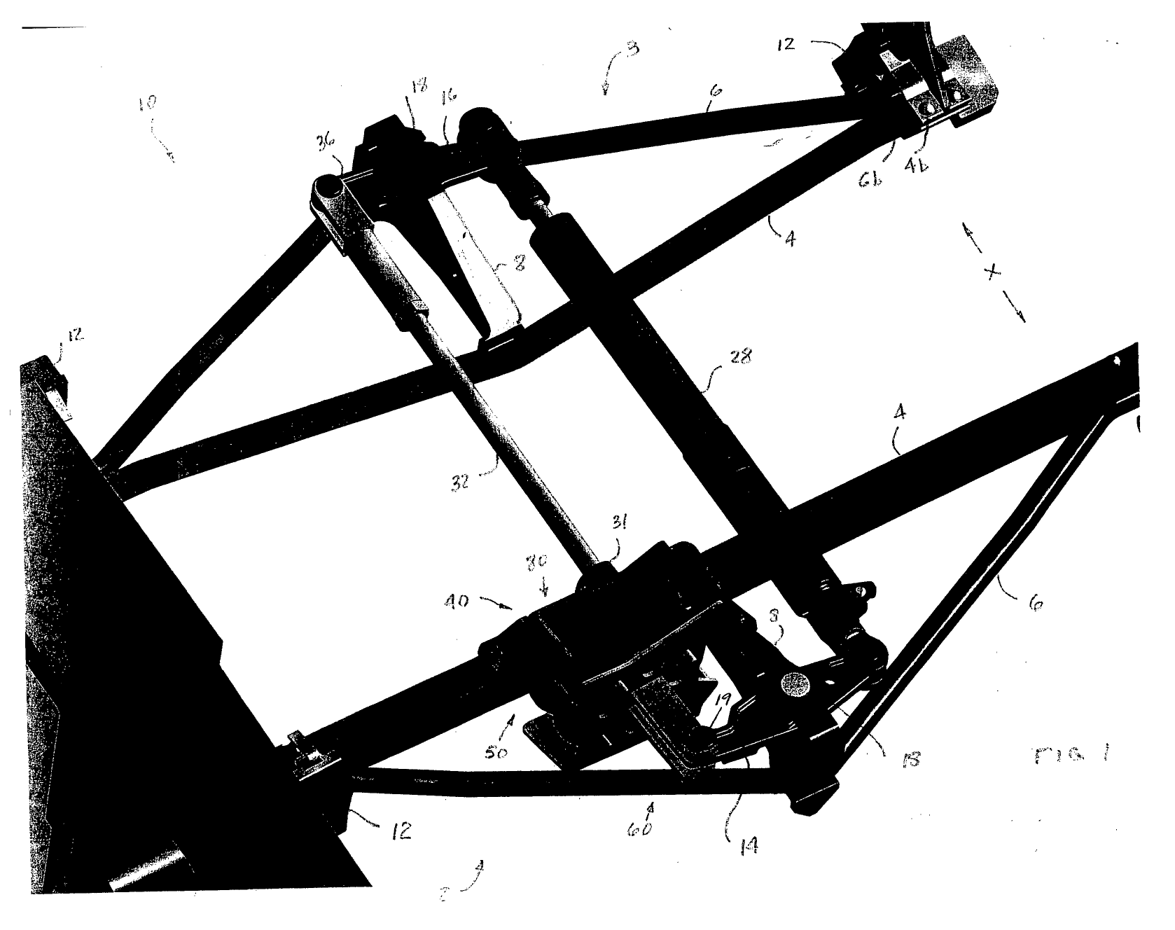

Referring now to FIG. 1, there is shown a presently preferred embodiment of a truck-mounted brake assembly, generally designated 10, for a railway car (not shown). This brake assembly 10 comprises brake beams, generally designated 2 and 3, which are substantially identical. Each of the brake beams 2 and 3 includes a compression member 4, a tension member 6 and a strut member 8. The opposite ends of the compression member 4 and the tension member 6 may be permanently connected together, preferably by welding, along an outer segment (not shown) at the opposite ends of the compression member 4 and the tension member 6.

At a location substantially midway between their opposite ends, the compression member 4 and the tension member 6 of the, respective, brake beams 2 and 3 are spaced apart sufficiently to allow connection of the strut member 8 therebetween. Mounted on the respective outer end segments of the brake beams 2 and 3 are brake heads 12.

A pair of force-transfer levers 14 and 16 are pivotally connected by pins 18 to the strut member 8 of the respective brake beams 2 and 3. One end of the respective force-transfer levers 14 and 16 is interconnected via a force-transmitting member 28, which may be in the form of a slack adjuster device. The opposed end 36 of the force-transfer lever 16 is connected to an at least one brake actuator assembly 40 by connecting means 31 via a force-transmitting member or a return push rod assembly 32.

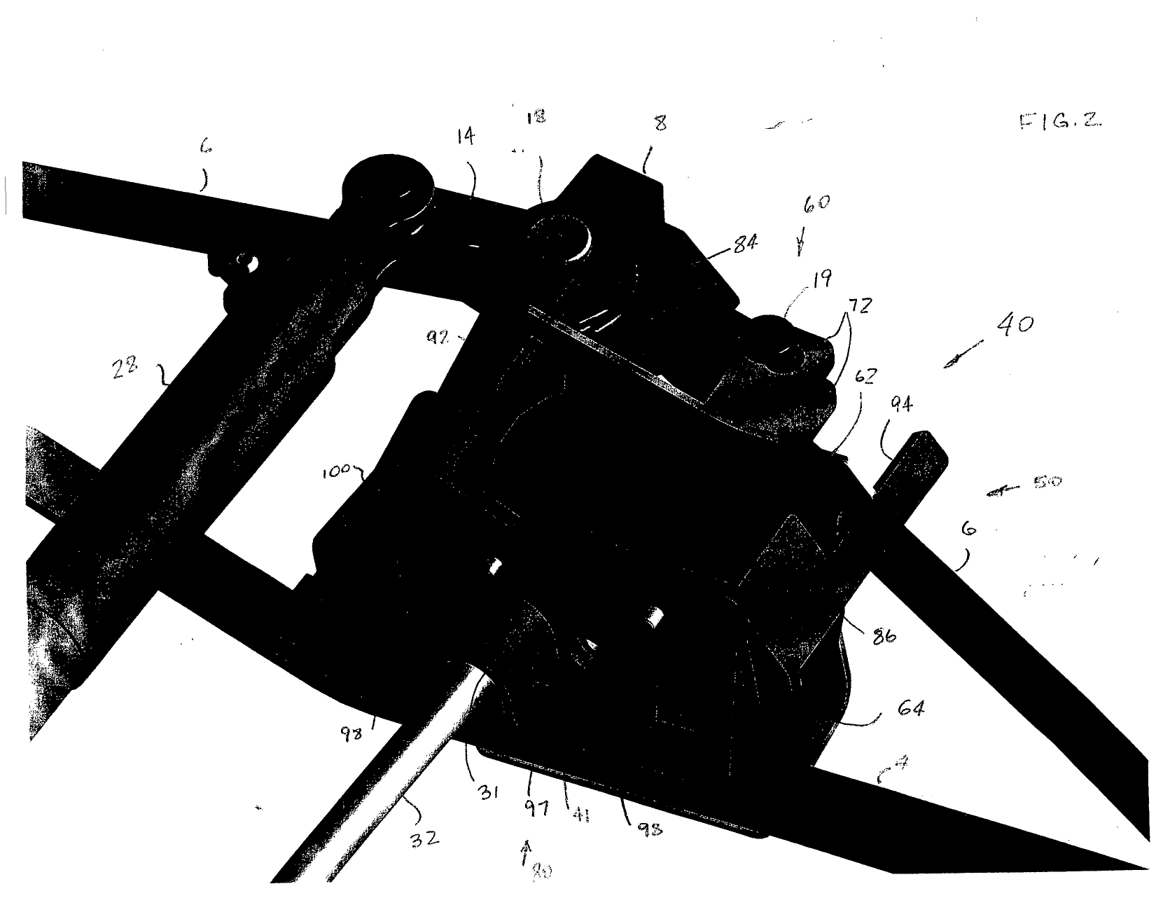

In further reference to FIGS. 1 and 2 when a brake application is made, pressurization of the air spring actuator, generally designated 50, will result in movement of pushrod/shield, generally designated 60, connected with force transfer lever 14 in a forward direction to effect a counterclockwise rotation of said force transfer lever 14. The force transfer lever 14, in turn, actuates the slack adjuster assembly 28 to effect counterclockwise rotation of the force-transfer lever 16 and consequent actuation of the return push rod assembly 32.

The force-transfer levers 14 and 16, along with the slack adjuster assembly 28, the return push rod assembly 32 and the brake actuator assembly 40 comprise a brake beam actuating linkage that interconnects the, respective, brake beams 2 and 3 via the pivot pins 18 and thus the required brake actuation forces effectively act along these pivot pins 18. The resultant of these forces is shown at X. Because the slack adjuster assembly 28 acts as a rigid member during a brake application, it is important that the length of the slack adjuster assembly 28 be allowed to increase with brake shoe wear and/or loss of a brake shoe during service so that movement of the pushrod/shield 60 will enable such brake beams 2 and 3 to be moved apart by the brake beams linkage until brake shoe engagement with the tread surface of the vehicle wheels occurs.

Any well-known technique may be used to position and/or mount the brake actuator assembly 40 to the braking system. For example, such brake actuator assembly 40 can be connected to both the strut member 8, adjacent one side thereof, and to the compression member 4 in the space located between the compression member 4 and the tension member 6. In this particular arrangement, the weight of the brake actuator assembly 40 and the force-transmitting members is carried by the brake beams 2 and 3, which are, in turn, supported by the truck side frames (not shown). A connecting means 31 is provided for connecting a back portion of the mounting member with the return push rod 32.

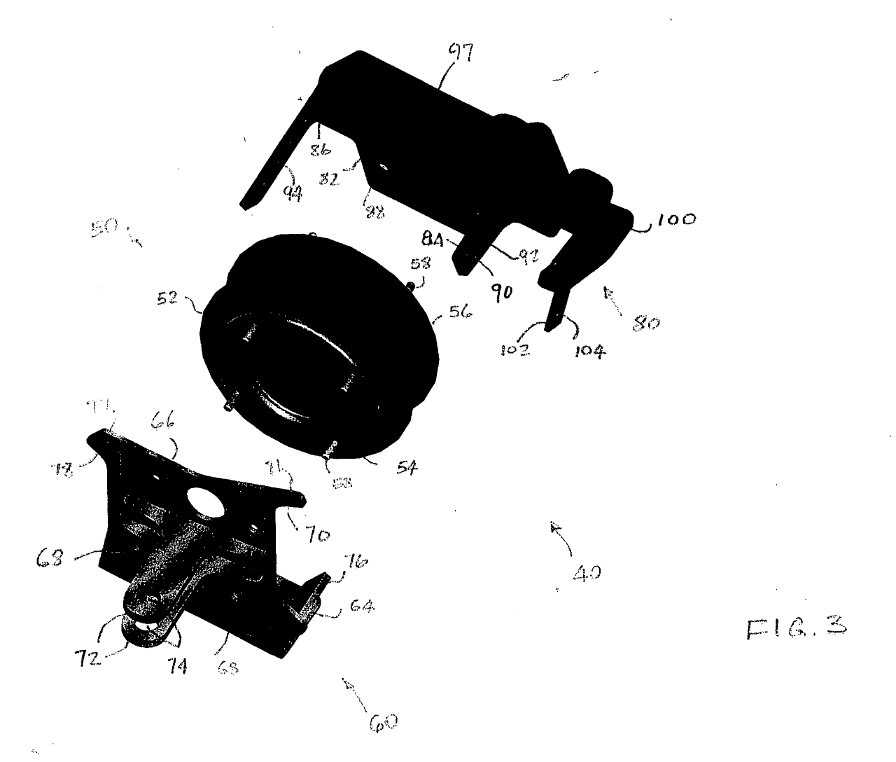

In reference to FIG. 3 brake actuator assembly 40 consists of at least one air spring actuator 50 disposed within pushrod/shield member 60 and a mounting bracket member, generally designated 80. At least one air spring 52 is substantially attached to a first surface 54 and an opposed second surface 56 substantially coplanar to said first surface 54. A pushrod/shied 60 is connected to the first surface 54 of the air spring 52 wherein at least one mounting member 58 will cooperate with at least one mounting cavity 68 disposed within first surface 66 of said pushrod/shield 60.

In the presently preferred embodiment this at least one mounting member 58 and at least one mounting cavity 68 are four mounting members 58 and four mounting cavities 68 respectively. This pushrod/shield 60 is capable of movement in an outward direction upon actuation of the air spring 52 to initiate a braking sequence of the railway vehicle braking system. A mounting bracket 80 is connected to the opposed second surface 56 of the air spring 52 wherein at least one mounting member 58 cooperates with an at least one mounting cavity 88 disposed within surface 82 of the mounting bracket 80. In the presently preferred embodiment there are four mounting members 58 and four mounting cavities 88 respectively.

In further reference to FIG. 2, at least one cavity 98 is provided for attachment of such mounting bracket 80 to the compression member 4. In the presently preferred embodiment there are two cavities 98. Furthermore, a support portion 100 substantially engages strut member 8 having tab member 102 and at least one mounting cavity 104 for attachment to such strut member 8 is provided to substantially minimize force loads acting on the brake actuator 40 upon actuation of the hand brake mechanism (not shown).

The air spring 52 includes air communication means 41, best shown in FIG. 2, in fluid communication with an interior portion of at least one air spring 52 for supplying air pressure to such at least one air spring 52 to cause actuation of this air spring 52 during a brake application and also for removing or evacuating air from the air spring 52 to cause deactivation of the air spring 52 during a brake release. In the presently preferred embodiment, this air communication means 41 is at least one air inlet port. Cavity 97 disposed within the mounting bracket is substantially aligned with the air communication means 41 to enable application of the pneumatic pressure within air spring 52. Forces generated upon pressurization of the air spring 52 vary with the respect to their travel height due to the natural characteristics of the rubber. The pressurization and discharge of the air spring actuator is regulated by an external control circuit (not shown). Furthermore, these forces vary at the constant pressure applied to the air spring 52.

Any commercially available inflatable spring may be used as long as this spring is capable of withstanding the amount of air pressure applied thereto and capable of providing sufficient force to move pushrod/shield 60 to initiate a braking sequence.

At least one cavity 74 is provided in at least one force transfer lever engaging portion 72 of such pushrod/shield 60 for connection with force-transfer levers 14 and 16 by pins 19. In further reference to FIG. 3, pushrod/shield 60 having second and third surface portions 64 and 76 substantially horizontal to first surface portion 66 protects air spring actuator 50 from foreign objects during railway vehicle movement. First edge portion 70 and second edge portion 78 engage first edge portion 84 and second edge portion 94 respectively of the mounting bracket 80 for guiding the air spring actuator 50 during reciprocal movement of such air spring actuator 50 to provide for linkage bail and/or misalignment without applying loads to the air spring actuator 50.

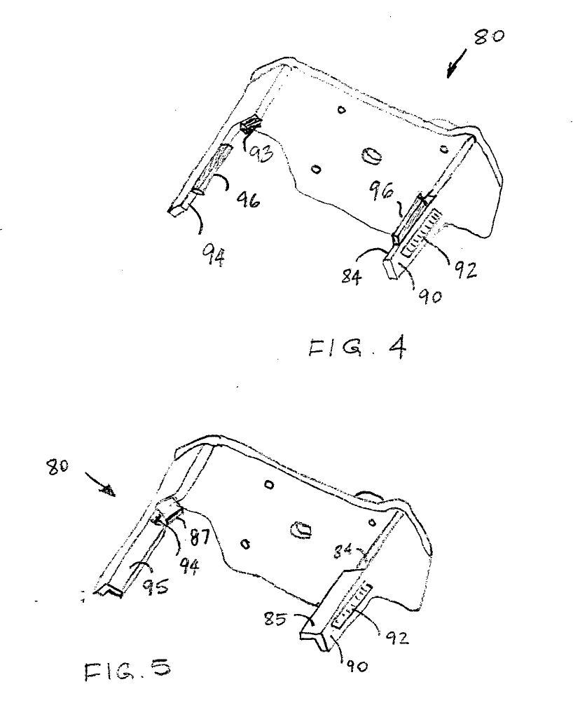

In the presently preferred embodiment, edge portions 70, 78, 84 and 94 are simple edge portions produced by either a casting or forging method. Alternatively, at least one wear resistant member 96 of predetermined material is attached to such edge portions 84 and 94, as shown in FIG. 4, to substantially minimize damage to edge surfaces 70 and 78 during railway vehicle motion. Yet alternatively, damage to edge surfaces 70 and 78 is substantially minimized by such simple edge portions 84 and 94 having second surface portions 85 and 95 substantially perpendicular to the edge surfaces 84 and 94 respectively as shown in FIG. 5.

In further reference to FIG. 3, a linear travel height indicator 92 is attached to surface portion 90 of the mounting bracket 80 permitting determination of the forces generated upon pressurization of the air spring 52 that vary with respect to their travel height due to the natural characteristics of the rubber.

In the preferred embodiment, upon discharge of the spring actuator 50, stop portion 77 of pushrod/shield 60 will engage a third edge portion 86 of the mounting bracket 80 preventing further motion of the spring actuator 50 and, more particularly, preventing damage to air spring 52. Alternatively, stop 77 can be incorporated and disposed internally within air spring 52 having substantially identical functionality as edge portion 86.

Furthermore, it is preferred that edge portion 86 be produced by a casting or forging process. Alternatively, at least one wear resistant member 93 of predetermined material is attached to edge portion 86 to substantially minimize damage to edge surface 77 during railway vehicle motion. Yet alternatively, damage is substantially minimized with edge portion 86 having an adjoining surface portion 87 substantially perpendicular to said edge portion 86.

Currently used brake cylinder assemblies may be retrofitted with the air spring actuator assembly of the present invention by substantially replacing the cylinder assembly with the air spring actuator assembly having a predetermined push rod/shield and mounting bracket arrangements to interface with the existing brake assembly arrangement.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

1. An actuating member for a railway vehicle brake assembly, such railway vehicle brake assembly having an air bag actuator incorporated therein, said actuating member comprising:
(a) a first substantially vertically disposed plate like member, said first substantially vertically disposed plate like member having a first substantially planer surface engageable with a first surface of a second substantially vertically disposed plate like member attached to such air bag actuator;
(b) a substantially horizontally disposed plate like member connected to said first substantially vertically disposed plate like member adjacent a bottom edge thereof and extending substantially perpendicular to said first substantially planer surface of said first substantially vertically disposed plate like member for shielding at least a first portion of such air bag actuator from detrimental extraneous foreign material; and
(c) a means connected to a radially opposed second surface of said first substantially vertically disposed plate like member for securing said actuating member to a control linkage of such railway vehicle brake assembly.

2. An actuating member, according to claim 1, wherein said actuating member further includes a first plate like member connected to an upper surface of said substantially horizontally disposed member and to said first planer surface of said first substantially vertically disposed plate like member adjacent a first side edge thereof and extending substantially perpendicular thereto for shielding at least a second portion of such air bag actuator from detrimental extraneous foreign material and for providing added strength between said first substantially vertically disposed member and said substantially horizontally disposed member.

3. An actuating member, according to claim 2, wherein said actuating member further includes a second plate like member connected to said upper surface of said substantially horizontally disposed member and to said first planer surface of said first substantially vertically disposed plate like member adjacent a second side edge thereof and extending substantially perpendicular thereto for shielding at least a third portion of such air bag actuator from detrimental extraneous foreign material and for providing added strength between said first substantially vertically disposed member and said substantially horizontally disposed member.

4. An actuating member, according to claim 1, wherein said first substantially vertically disposed plate like member includes at least one mounting aperture formed therethrough for enabling securing of such air bag actuator to said first substantially vertically disposed member.

6. An actuating member, according to claim 1, wherein said means connected to said radially opposed second surface of said substantially first vertically disposed plate like member for securing said actuating member to such control linkage of such railway vehicle brake assembly includes at least one plate member having an aperture formed therethrough and a pin member disposed in said aperture for securing said at least one plate member to such control linkage.

7. An apparatus for mounting an air bag actuator to at least one brake beam, said apparatus comprising:
(a) a first substantially vertically disposed plate like member having a planar surface portion for engagement with a substantially planar surface portion of a second substantially vertically disposed plate like member connected to such air bag actuator;
(b) a guide means connected to and disposed closely adjacent a first outer edge of and substantially perpendicular to said planer surface portion of said first substantially vertically disposed plate like member for guiding and alignment during reciprocal motion of such air bag actuator; and
(c) a securing means connected to said first substantially vertically disposed plate like member for enabling attachment of said apparatus to a rigid structure.

8. An apparatus, according to claim 7, wherein said apparatus includes a pair of guide means, a second one of said pair of guide means disposed closely adjacent a second outter edge of and substantially perpendicular to said planer surface portion of said first substantially vertically disposed plate like member for guiding and alignment during reciprocal motion of such air bag actuator

9. An apparatus, according to claim 7, wherein said planar surface portion of said first substantially vertically disposed plate like member includes at least one aperture formed therethrough for enabling attachment to such air bag actuator.

10. An air spring actuator assembly, said air spring actuator assembly comprising:
(a) at least one air bag spring;
(b) a first substantially vertically disposed plate like member, said first substantially vertically disposed plate like member having a first substantially planer surface engageable with a first surface of a second substantially vertically disposed plate like member attached to said at least one air bag spring;
(c) a substantially horizontally disposed plate like member connected to said first substantially vertically disposed plate like member adjacent a bottom edge thereof and extending substantially perpendicular to said first substantially planer surface of said first substantially vertically disposed plate like member for shielding at least a first portion of said at least one air bag spring from detrimental extraneous foreign material;
(d) a means connected to a radially opposed second surface of said first substantially vertically disposed plate like member for securing said actuating member to a control linkage of a railway vehicle brake assembly;
(e) a second substantially vertically disposed plate like member having a second planar surface portion for engagement with a substantially planar surface portion of a second substantially vertically disposed plate like member connected to such air bag spring;
(f) a guide means connected to and disposed closely adjacent a first outer edge of and substantially perpendicular to at least one of said first and said second planer surface portion of a respective one of said first and said second substantially vertically disposed plate like member for guiding and alignment during reciprocal motion of such air bag actuator; and
(g) a securing means connected to said second substantially vertically disposed plate like member for enabling attachment of said apparatus to a rigid structure.

11. An air spring actuator assembly, according to claim 10, wherein said means connected to a radially opposed second surface of said first substantially vertically disposed plate like member for securing said actuating member to a control linkage of a railway vehicle brake assembly includes a push rod and a shield member for substantially protecting said air spring actuator from foreign matter damage.

12. An air spring actuator, according to claim 10, wherein said air spring actuator further includes a means for limiting reciprocal motion of the said air spring actuator during evacuation of air pressure from said at least one air bag spring.

13. An air spring actuator, according to claim 12, wherein said means for limiting reciprocal motion of said brake actuator is a rigid member disposed internally within said air spring actuator.

14. An air spring actuator, according to claim 10, wherein said air spring actuator further includes an air inlet in communication with said at least one air bag spring.

15. An air spring actuator, according to claim 10, wherein said air spring actuator further includes a means for visual determination of a travel height of said air spring actuator.

16. An air spring actuator, according to claim 11, wherein said air spring actuator further includes a means for guiding longitudinal motion of said push rod and shield for substantially minimizing force loads on said air spring actuator during reciprocal motion of said air spring actuator due to linkage bail and/or misalignment.

17. An air spring actuator, according to claim 10, wherein said air spring actuator further includes a visual travel indicator.

18. An air spring actuator, according to claim 17, wherein said visual travel indicator is a linear measuring device.

19. An air spring actuator, according to claim 10, wherein said air spring actuator further includes a means for controlling volume of said air spring actuator.
